(19) United States
(12) Patent Application Publication
(10) Pub. No.: US 2014/0092614 A1
(43) Pub. Date: Apr. 3, 2014

(54) STROBE MOUNT FOR VEHICLE MIRROR

(71) Applicant: FORD GLOBAL TECHNOLOGIES, LLC, Dearborn, MI (US)

(72) Inventors: Jeffrey Paul Duncan, Brighton, MI (US); James Michael Deneau, Macomb, MI (US); Doug Hank Randlett, Metamora, MI (US)

(73) Assignee: FORD GLOBAL TECHNOLOGIES, LLC, DEARBORN, MI (US)

(21) Appl. No.: 13/632,172

(22) Filed: Oct. 1, 2012

(51) Int. Cl. B60Q 1/46

(52) U.S. Cl. 362/494

(57) ABSTRACT

A light housing is adapted for attachment to a mirror unit and includes a light source. The light housing has a closed end, which includes at least three rearward sides, where the at least three rearward sides are adapted for engagement with the mirror unit. An opening formed in the closed end is adapted for attachment of the light source through the closed end.

### BACKGROUND

This application generally relates to the field of vehicular mirror assemblies, and, more particularly, relates to incorporating a light strobe mount into an outside rear view mirror (ORVM).

In the past, rear view mirrors or ORVMs, applied in vehicles, were primarily utilized by vehicular drivers to observe oncoming traffic from the vehicle's rear, while driving ahead. Over the years, certain improvements in ORVMs have occurred. One such improvement is the incorporation of lighting fixtures to enhance user appeal and market value of the related vehicle. Apart from having a visual appeal, some of these lighting fixtures serve other purposes. For example, a police vehicle may employ strobe lights as an emergency light mounted over the vehicle's rear view mirror. This is sometimes offered as an aftermarket attachment.

Aftermarket attachments, such as the ones noted above, are observed to become visually unappealing over time. In addition, with some of the aftermarket attachments including protruding elements, the attachments are observed to hamper the vehicle's aerodynamic capabilities as well. Further, being an aftermarket attachment, the reliability of the strobe mounts remains a concern too. On many occasions, the aftermarket strobe mounts are found to gather dust and excessive moisture when exposed to the outside environment. Moreover, the conventionally applied mounts are also vulnerable to accidental breakages. This calls for a more reliable incorporation of the strobe mounts into the vehicle's rear view mirror assemblies.

It is thus desirable to have rear view mirror assemblies in vehicles that can include a light strobe mount, and enhance visual appeal, while minimizing reliability concerns.

### SUMMARY

One embodiment of the present disclosure describes a light housing adapted for an attachment to a mirror unit. The light housing includes a light source and a closed end. The closed end has at least three rearward sides, which are in turn adapted for engagement to the mirror unit and includes an opening, formed in the closed end, which is adapted for attachment of the light source through the closed end.

Another embodiment of the present disclosure describes a light strobe mount adapted to be attached to a mirror unit. More particularly, the light strobe mount includes an open end, which is formed by at least three rearward sides and at least one forward side. All the sides are configured to include respective edges for engagement of the light strobe mount to the mirror unit. Further, the light strobe mount includes a closed end as well, which includes the at least three rearward sides, and an opening within which a light source is secured through a sealing grommet. Moreover, the light strobe mount includes a mounting periphery substantially mating with a peripheral attachment portion of the mirror unit such that upon attachment, the light strobe mount, the light source, and the mirror unit, form an integrated unit. More explicitly, both the closed end and the open end form the light strobe mount.

Certain embodiments of the present disclosure describe a method to incorporate a light source within a vehicle's outside rear view mirror (ORVM). The method includes first removing a trim piece from the ORVM, where the ORVM forms a mirror unit without the trim piece, and secondly, attaching a light housing to the mirror unit. Here, the light housing is configured to include the light source. More particularly, the light source includes an open end formed by at least three rearward sides and at least one forward side, and a closed end that includes the at least three rearward sides, and an opening within which the light source is secured. The closed end and the open end collectively form the light housing.

### BRIEF DESCRIPTION OF THE DRAWINGS

The figures described below set out and illustrate a number of exemplary embodiments of the disclosure. Throughout the drawings, like reference numerals refer to identical or functionally similar elements. The drawings are illustrative in nature and are not drawn to scale.

FIG. 1 is a conventional outside rear view mirror (ORVM) employed in a vehicle.

FIG. 2 is a cross sectional view of the conventional ORVM of FIG. 1.

FIG. 3A is an isometric view of an exemplary light strobe mount according to the aspects of the present disclosure.

FIG. 3B is a front view of the exemplary light strobe mount depicted in FIG. 3A.

FIG. 3C is a rear view of the exemplary light strobe mount depicted in FIG. 3A.

FIG. 3D is a top view of the exemplary light strobe mount depicted in FIG. 3A.

FIG. 3E is a bottom view of the exemplary light strobe mount depicted in FIG. 3A.

FIG. 3F is a right side view of the exemplary light strobe mount depicted in FIG. 3A.

FIG. 4A is an isometric rear view of a sealing grommet employed within the light strobe mount of FIG. 3A.

FIG. 4B is a front view of the sealing grommet depicted in FIG. 4A.

FIG. 4C is a top view of the sealing grommet depicted in FIG. 4B.

FIG. 4D is a right side view of the sealing grommet's front view depicted in FIG. 4B.

FIG. 5 is a light unit configured to be employed within the light strobe mount of FIG. 3A.

FIG. 6 is an isometric view of the light strobe mount of FIG. 3A when employed within the ORVM of FIG. 1.

FIG. 7 is an exemplary left side cross sectional view of the strobe mount of FIG. 3A employed within the ORVM of FIG. 1.

### DETAILED DESCRIPTION

The following detailed description is made with reference to the figures. Exemplary embodiments are described to illustrate the subject matter of the disclosure, not to limit its scope, which is defined by the appended claims.

### Overview

In general, the present disclosure relates to an outside rear view mirror (ORVM), installed in vehicles, which is configured to include a strobe light. To this end, a light housing is adapted to be incorporated to the ORVM. The light housing, more particularly, includes an open end and a closed end, where a set of three rearward sides and a forward side form the open end, while the closed end is formed by the three rearward sides, opposite end to the open end. Further, the closed end includes a light source.

### Exemplary Embodiments

Aesthetically pleasing external fittings for vehicles is of a reasonably high value in today's marketplace. Inspite of considerable costs involved however, conventionally applied aftermarket solutions, in general, may not always prove to be a reliable and aesthetically satisfying solution to accommodate specific requirements in vehicles. With many aftermarket solutions falling prey to reliability issues, automotive manufactures have long worked on providing aftermarket accessories and fittings that are desired by customers. One such fitting of concern are fittings used to incorporate strobe lights in vehicles, and more particularly, on police vehicles. The present disclosure describes in detail a modified trim piece that can be attached to the side rear view mirrors, referred to as the outside rear view mirrors (ORVMs), on vehicles, which aesthetically integrates a light source into the ORVMs. The modified trim piece may also be understood to be an original equipment manufacturer (OEM) replacement to a conventional trim piece.

To this end, the present application proposes a fitting, which may be an aftermarket fitting, that includes a light housing configured to form a light strobe mount to mount a strobe light. An exemplary construction of the light strobe mount of the present disclosure is such that it substantially bulges out of the ORVMs, when compared to conventional designs. Here, the bulge provides an enclosure, room, or a housing, to an incorporated light source, which in turn forms a corresponding strobe light. It is understood that the aftermarket fitting being discussed, may be fitted at a factory level as well.

To understand the aspects of the present disclosure in further detail, the figures provided first include a depiction of the prior art, while the figures provided thereafter, disclose the details of the proposed application in detail.

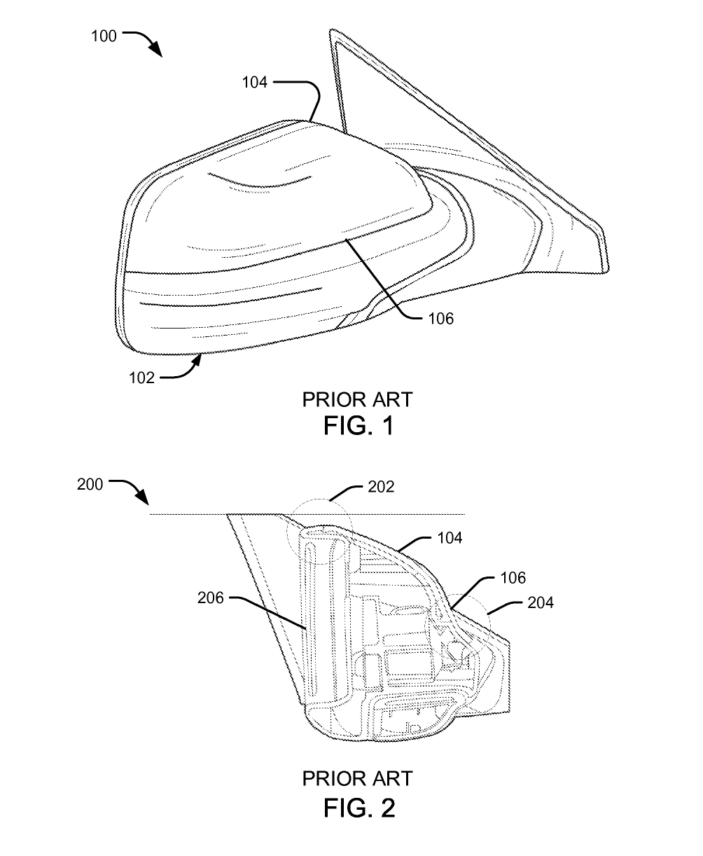

Turning therefore to FIG. 1, a conventionally applied ORVM 100 is depicted. The ORVM 100 houses a mirror 206 (shown in FIG. 2) adapted for an application by a vehicle driver. Further, a trim piece 104 forms an exterior portion of the ORVM 100. In the present application, a removal of the trim piece 104 from the ORVM 100 enables the ORVM 100 to form a mirror unit 102. Accordingly and more specifically, the mirror unit 102 may be understood as being the ORVM 100, without the trim piece 104. Being an assembled part component, the trim piece 104 includes a parting curve 106, establishing a mounting peripheral for the trim piece 104 to the mirror unit 102, as shown. It is understood that an accurate match of a mounting peripheral of the trim piece 104 to a peripheral attachment portion of the mirror unit 102 (also understood through the same parting curve 106), enables an appropriate assembly of the trim piece 104 to the mirror unit 102. This, more particularly, enables the trim piece 104 to appear as being fully integrated to the mirror unit 102, thus forming the entire ORVM 100. The trim piece 104 is assembled to the mirror unit 102 as an external part component during the manufacturing process, and this allows for removal of the trim piece 104. Such a removal is provided for to enable aftermarket attachments and mountings to be added to the ORVM 100.

FIG. 2, depicting a cross sectional view of a mounting scheme 200 of the trim piece 104 on the mirror unit 102, illustrates how the trim piece 104 is conventionally attached to the mirror unit 102. Regions 202 and 204 depict snap fitting engagements of the trim piece 104 to the mirror unit 102. Accordingly, it is well understood that a snap fitting arrangement enables the trim piece 104 to be relatively easily removed from the mirror unit 102. With all such details, embodiments, and configurations of the mirror unit 102 being well known to the skilled in the art, the mirror unit 102 will not be discussed in the application.

As discussed above, the present disclosure allows one to replace the disclosed trim piece 104 with an alternate mount or a housing that aesthetically mounts an emergency strobe light to the ORVM 100. Accordingly, the trim piece 104, being manufactured by original equipment manufacturers (OEM), may optionally be replaced by an aftermarket attachment.

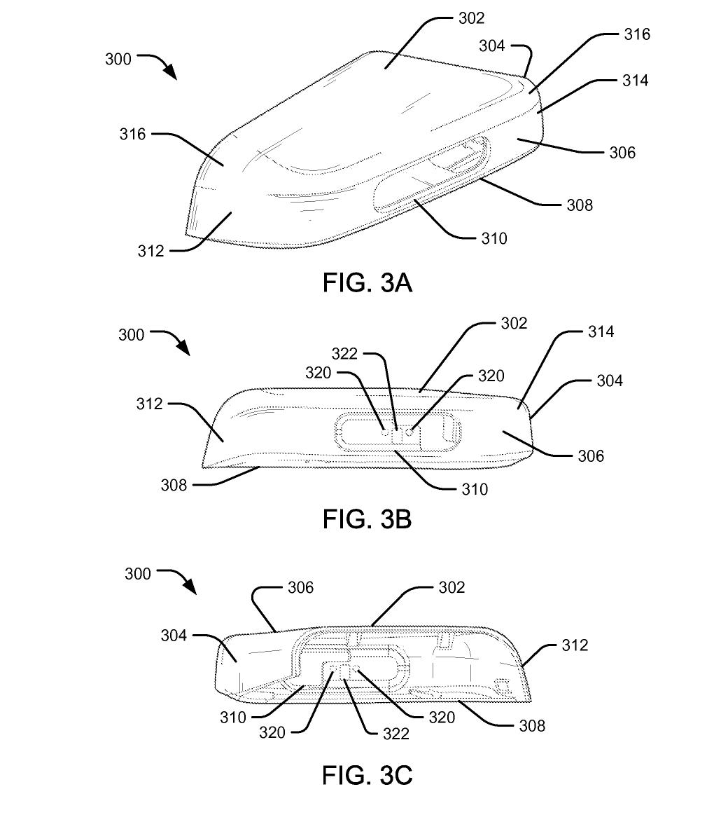

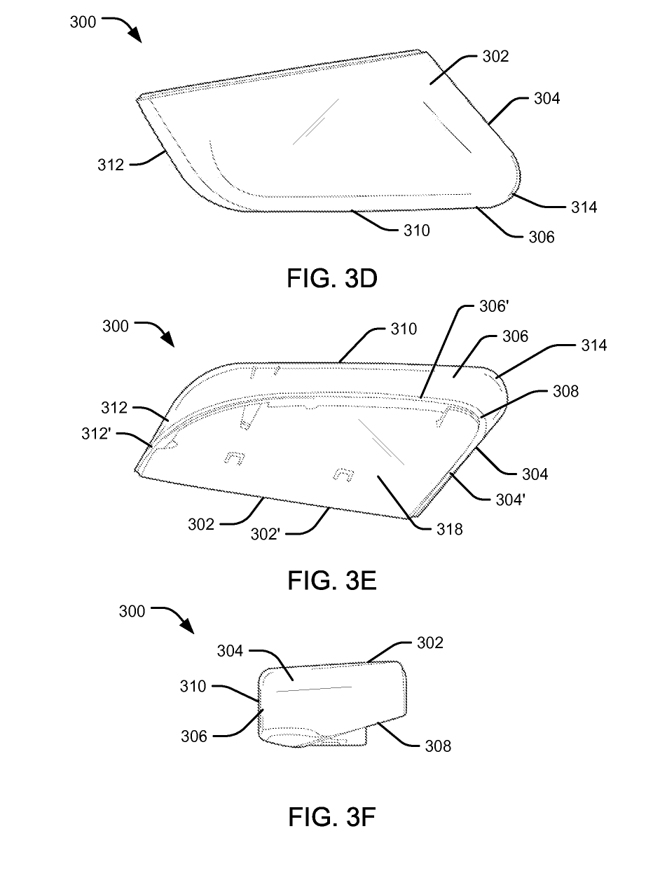

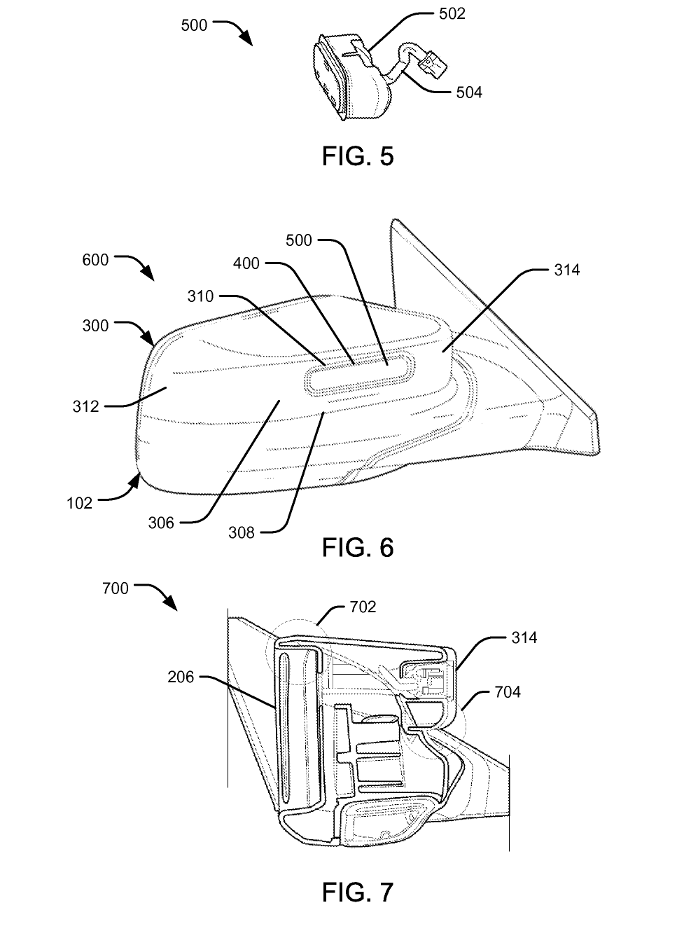

The disclosed application is understood further in detail through FIG. 3A, which illustrates a light housing, referred to as a light strobe mount 300. Structurally, the light strobe mount 300 includes at least three rearward sides, namely, a left side 312, a right side 304 (shown more clearly in FIG. 3C), a top side 302, along with a forward side 306, as shown. All the three sides 312, 304, and 302, along with the forward side 306, are roughly disposed at right angles to each other, while being connected to each other via filleted corners 316, as shown. Interior portions of the sides 312, 304, 306, and 302, depicted in substantial clarity in FIG. 3E, may include sections and channels (not shown) for the wiring's passages, enabling electrical connections. In other embodiments (not shown), a light source can be attached to the outside of the mount 300. More particularly, the sides 312, 304, 302, and 306, forming substantially the entire light strobe mount 300, exemplarily includes a bulge portion 314 in its structure, which extends beyond the outer boundaries of the ORVM 100 when fitted with the trim piece 104. Moreover, the bulge portion 314 enables the light strobe mount 300 to be exemplarily in the form of a wave like housing, primarily catering to the attachment, securing, and housing, of a strobe light referred to as a light source 500 (depicted in FIG. 5) within an opening 310. The opening 310 is formed in a closed end (discussed later) of the light strobe mount 300, where the attachment of the light source 500 is enabled through the closed end. More specifically, the opening 310 is formed within the forward side 306, as part of the closed end, as shown. More to the structure, the light strobe mount 300 includes a mounting periphery 308 adapted to substantially mate with a peripheral attachment portion of the mirror unit 102, such that, upon mating and a subsequent attachment, the light strobe mount 300, light source 500, and the mirror unit 102, form an integrated unit. All the sides 312, 304, 302, and 306, include edges 312′, 304′, 302′, and 306′, respectively, to form the mounting periphery 308, which in turn enables an engagement and attachment of the housing, and, more particularly, of the light strobe mount 300 to the mirror unit 102. Optionally, a seal for engagement may be incorporated at the edges 312′, 304′, which may be any of the conventionally applied seals, well known in the art, specified for such engagements. An incorporation of a seal may however vary from practice-to-practice, and may thus be configured to enhance protection of an internal region of the mount 300 from the outside environment. It is understood that light strobe mount 300, being primarily applied as a light housing for the inclusion of the light source 500, allows for its reference as a light housing. Besides, the light strobe mount 300, may differ in shape and configurations from the ones disclosed in the application, and accordingly, the shape and configurations of the light strobe mount 300 disclosed here need not be viewed as limiting in any way.

To understand the construction of the light strobe mount 300 in further detail, FIGS. 3B, 3C, 3D, 3E, and 3F, illustrate different views of the light strobe mount 300. Accordingly, FIG. 3B includes a depiction of the front view of the light strobe mount 300, and, more particularly, the figure depicts the mount's closed end to which a strobe light is adapted to be secured. The closed end includes the three rearward sides 312, 304, 302, which are adapted for engagement with the mirror unit 102. More particularly, the mounting periphery 308 and the opening 310, included as part of the closed end, and as discussed above, may be observed in further detail as well. Another visible detail is the provision of apertures 320 within an interior region of the opening 310, as shown, that permits riveted or screwed fastenings of the light source 500 to the opening 310, and thus, to the light strobe mount 300. Moreover, a slot 322 allows for a passage to wires extending from the light source 500, enabling the light source 500 to be linked to a source of power, once the light source 500 is secured within the opening 310. FIG. 3C, correspondingly, depicts a view of the light strobe mount 300, disposed opposite to the closed end depicted in FIG. 3B, and thereby, depicts an open end of the light strobe mount 300. A rear view of the opening 310 is visible and is thus understood further that the three rearward sides 312, 302, and 304, along with the forward side 306, form the open end. Such an arrangement enables the open end to include the mirror 206, and allows the mirror 206 to be visible through the open end. Moreover, the figure illustrates the right side 304, disclosed in FIG. 3A, in substantial clarity as well. The closed end and the open end together form the light strobe mount 300, as shown.

Turning to FIGS. 3D and 3E, a top view and a bottom view of the light strobe mount 300 will now be described, respectively. Accordingly, FIG. 3D depicts a top profile of the light strobe mount 300, through which the bulge portion 314 may be understood and visualized more clearly. The top profile, and more specifically, the top side 302, includes a substantially planer profile, which is suited to aid in an aerodynamic flow of air around the mount 300, during a vehicle travel. Likewise, it is understood that the sides 312, 304, and 306, all work to improve airflow around the strobe mount 300 as well, which is observed to be missing in the conventionally applied aftermarket solutions. Furthermore, the bottom view depicted in FIG. 3E provides for a clearer internal view of the strobe mount 300. More particularly, the forward side 306 extends substantially towards an interior region 318, as shown. The mounting periphery 308 is visible to a considerable extent in this view, and has the sides 312, 304, 306, and 302, extending to form the mounting periphery 308, enabling the light strobe mount 300 to mate with the mirror unit 102, to which the trim piece 104 is generally assembled. It will thus be understood that a mating contour of the trim piece 104 and a mating contour of the light strobe mount 300 are similar, enabling the light strobe mount's attachment to the mirror unit 102 in place of the trim piece 104. To enable further clarity to the structure, and more explicitly, to the right side 304, a right hand side view of the light strobe mount 300 is depicted in FIG. 3F.

Materials to manufacture the light strobe mount 300 may include conventionally applied high grade and/or ding resistant plastics, polymers, etc., while manufacturing the mount 300 may include conventionally applied injection molding techniques, etc.

Structures, and housings, that include sides, such as the ones described in the present application so far, which are in turn used to house a light source, when configured to be fitted onto a conventional ORVM, may all be understood to be covered under the aspects of the present disclosure.

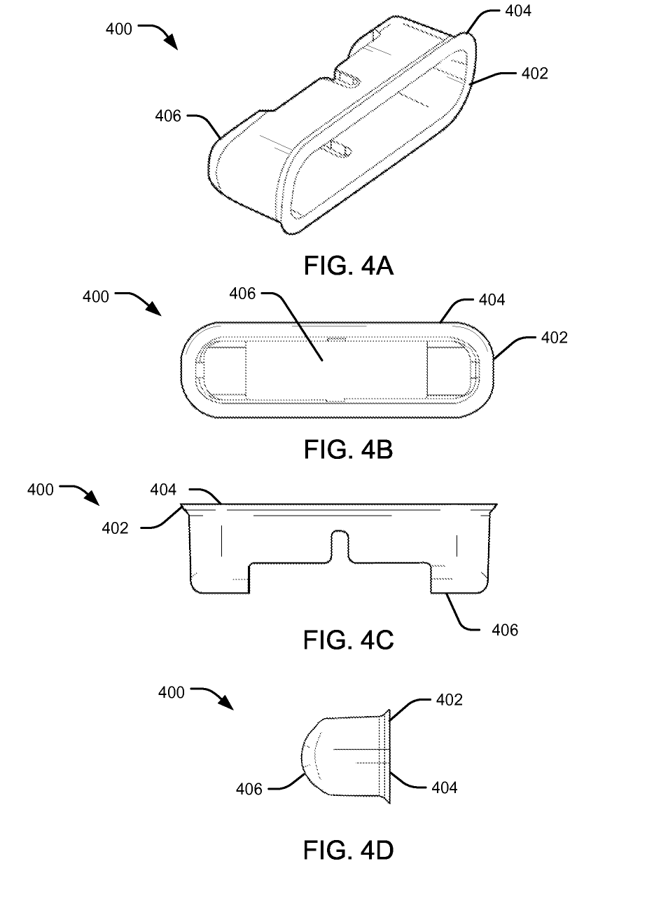

Turning now to FIG. 4, a sealing grommet 400 is described. The sealing grommet 400 is a seal, configurations, variations, and embodiments, of which finds use in several conventional applications. Structurally, the sealing grommet 400 includes a substantially rectangular cross sectional profile, rounded at its opposite edges, and includes a collar section 402 at a rear end 404, as shown, enabling the grommet 400 to be fitted and locked to an exterior boundary of the opening 310. The collar section 402, more specifically, restricts the sealing grommet 400 from travelling deeper into the opening 310, or further inside towards the region 318, during an assembly, as well as, during an application. Moreover, a front end 406 is included in the grommet 400, which likewise, includes a considerably rounded configuration as well. This is because a rounded configuration generally enables easier manufacturing, which is observed to be true particularly when the component's ejection procedures require to be carried out. More particularly, the sealing grommet 400 is configured to act effectively as an interface between the accommodated light source 500 (shown in FIG. 5) and the opening 310. Through the sealing grommet 400, the accommodation of the light source 500 is enabled with a minimal or negligible clearance so that the light source 500 and the region 318, disposed within the light strobe mount 300, can sufficiently be protected from an outside whether and from other external elements during operations and even during idle conditions. Correspondingly, the sealing grommet 400 includes exterior configurations that allow for the grommet's appropriate fit within the confines of the opening 310. Furthermore, the grommet 400 may include well known fastening mechanisms (not shown) such as snap fits, clipping sections, positive attachment mechanisms, such the ones obtained through screws and rivets, etc., to enable attachment into the opening 310, enabling the grommet 400 to be positively fitted to the light strobe mount 300. Accordingly, along with providing attachment mechanisms to the light source 500, it is understood that the apertures 320 allow for attachments of the sealing grommet 400 as well. The subsequent figures, namely, FIGS. 4B, 4C, and 4D, depict a front view, a top view, and a right hand side view, of the sealing grommet 400, respectively, to further enable an understanding of the overall structure of the grommet 400. Alike the structure of the light strobe mount 300, it is understood that the discussed structure of the sealing grommet 400 does not limit the scope of the present disclosure in any way.

Materials to manufacture the sealing grommet 400 may include any of the conventionally applied materials that are applied in making seals. For example, polyurethane, compounds of rubber, applied polymers, etc. Further, the techniques to manufacture the sealing grommet 400 may include injection molding, and the like.

As discussed above, FIG. 5 includes the light source 500 that is adapted to be fitted into the opening 310, once the sealing grommet 400 is fitted into the opening 310. Provisions within the sealing grommet 400 can include positive attachment features, such as the ones enabled through snap-fits, rivets, and screws (not shown), to secure the light source 500 into the grommet 400, and, more explicitly, to the light strobe mount 300. Again, apertures 320 allow for the related securing mechanisms. The light source 500 may be a conventionally known light source, such as conventionally available emergency lights, Light Emitting Diodes (LEDs), etc. Being substantially similar in exterior configurations to the internal confines of the opening 310, and more particularly, to the inner confines of the sealing grommet 400, the light source 500 includes a substantially rectangular outer profile. According to the aspects of the present disclosure, the light source 500 is accustomed to work as an emergency strobe light in police vehicles. It is however understood that the light source 500 is not restricted to an application within police vehicles alone, and accordingly, the light source 500 may be incorporated to enhance a visual appeal of the vehicle, as well. It is further understood that the stated applications does not restrict or limit the usage of the light source 500 and, broadly, the light strobe mount 300, in any way. At a rear portion 502, of the light source 500, which faces the region 318 disposed within the light strobe mount 300, there includes a provision for wirings 504 and related connectors to extend out of the light source 500, enabling the light source 500 to be physically linked to a power source. As noted above, channels (not shown) are provided within the light strobe mount 300 to enable passages for such wirings and related connections, which enables the linkage to a power source.

An assembly of the light strobe mount 300 will thus include the light strobe mount 300 to be incorporated with the sealing grommet 400 in the closed end, within which, the light source 500 is configured to be housed, secured, and sealed.

FIG. 6 accordingly depicts the assembly of the light strobe mount 300 mounted to the mirror unit 102 to form an ORVM 600. Accordingly, the ORVM 600 is partially similar in appearance to the ORVM 100. A difference in appearance, however, between the ORVM 600 and the ORVM 100, is observed because of the bulge portion 314. This difference can be visualized more clearly when a cross-sectional profile 700 of the ORVM 600, depicted in FIG. 7, is compared to the one depicted in FIG. 2. An incorporation of the light strobe mount 300 enables the ORVM 600 to appear visually appealing, than when a light strobe mount is installed as an aftermarket attachment. Moreover, such an incorporation of the light strobe mount 300 enables the light source 500, and the region 318 disposed within the light strobe mount 300, to be protected from the outside environment as well.

An exemplary method to install or incorporate the light strobe mount 300 will conventionally include removing the trim piece 104 from the ORVM 100 (shown in FIG. 1), and thereafter, attaching the light strobe mount 300 to the mirror unit 102, enabling the ORVM 100 to become the ORVM 600. Here, the removal process may include conventional techniques well known in the art. Further, an attaching mechanism is understood to be enabled through snap fits, and the like. Regions 702 and 704 marked in FIG. 7 depict the light strobe mount's mounting scheme, which remains similar to that of the trim piece 104 as shown in FIG. 2. Accordingly, the mounting mechanism may include similarly disposed snapping members, clipping members, or the like. Optionally, and as noted above, the method of attaching or installing may include sealing the edges 312′, 304′, 302′, and 306′, of the sides disposed at the open end, namely the sides 312, 304, 302, and 306, through a seal for an engagement of the light strobe mount 300 to the mirror unit 102. In some embodiments, mount 300 may attach to the mirror unit 102 through clips, adhesive, heat stakes, etc. Moreover, as noted above, it is understood that the installation of the light strobe mount 300 to the mirror unit 102 may be performed at a factory level as well, where a removal of the trim piece 104 may not be required.

The specification has set out a number of specific exemplary embodiments, but those skilled in the art will understand that variations in these embodiments will naturally occur in the course of embodying the subject matter of the disclosure in specific implementations and environments. It will further be understood that such variation and others as well, fall within the scope of the disclosure. Neither those possible variations nor the specific examples set above are set out to limit the scope of the disclosure. Rather, the scope of claimed invention is defined solely by the claims set out below.

We claim:

1. A light housing adapted for attachment to a mirror unit and to include a light source, the light housing comprising:
a closed end including at least three rearward sides, the at least three rearward sides being adapted for engagement with the mirror unit; and
an opening formed in the closed end adapted for attachment of the light source through the closed end.

2. The light housing of claim 1 further comprising an open end formed by the at least three rearward sides and at least one forward side, all sides including respective edges for engagement of the light housing to the mirror unit, the open end including a mirror visible through the open end, the closed end and the open end forming the light housing.

3. The light housing of claim 1, wherein the light housing includes a mounting periphery adapted to substantially mate with a peripheral attachment portion of the mirror unit such that, upon attachment, the light housing, the light source, and the mirror unit, form an integrated unit.

4. The light housing of claim 1, wherein the mirror unit is an outside rear view mirror installed in a vehicle, without a trim piece, wherein the light housing attaches to the mirror unit upon a removal of the trim piece from the mirror unit.

5. The light housing of claim 4, wherein a mating contour of the trim piece and a mating contour of the light housing are similar, enabling the light housing's attachment to the mirror unit in place of the trim piece.

6. The light housing of claim 1, wherein the light housing is a light strobe mount, and the light source is a strobe light secured in the opening through the closed end.

7. The light housing of claim 6, wherein the strobe light is at least one of the following:
an emergency light; and
a light emitting diode.

8. The light housing of claim 6, wherein the strobe light is sealed within the opening of the light housing through a sealing grommet.

9. A light strobe mount adapted to be attached to a mirror unit, the light strobe mount comprising:
an open end, formed by at least three rearward sides and at least one forward side, all the sides including respective edges for engagement of the light strobe mount to the mirror unit;
a closed end, including an opening and the at least three rearward sides, wherein the closed end and the open end form the light strobe mount; and
a light source, secured within the opening through a sealing grommet, wherein the light strobe mount includes a mounting periphery substantially mating with a peripheral attachment portion of the mirror unit such that upon an attachment, the light strobe mount, the light source, and mirror unit, form an integrated unit.

10. The light strobe mount of claim 9, wherein the mirror unit is a vehicular outside rear view mirror without a trim piece.

11. The light strobe mount of claim 10, wherein the light strobe mount attaches to the mirror unit upon a removal of the trim piece from the vehicular outside rear view mirror.

12. The light strobe mount of claim 10, wherein a mating contour of the trim piece and a mating contour of the light strobe mount are similar, enabling the light strobe mount's attachment to the mirror unit in place of the trim piece.

13. The light strobe mount of claim 9, wherein the light source is at least one of the following:
an emergency light; and
a light emitting diode.

14. A method to incorporate a light source to a vehicle's outside rear view mirror, the method comprising:
removing a trim piece from the outside rear view mirror, the outside rear view mirror thereby forming a mirror unit without the trim piece;
attaching a light housing, having the light source, to the mirror unit, the light housing including:
an open end formed by at least three rearward sides and at least one forward side; and
a closed end including an opening and the at least three rearward sides, the closed end and the open end forming the light housing, wherein the light source is configured to be secured within the opening.

15. The method of claim 14, wherein the at least three rearward sides and the at least one forward side includes respective edges for an engagement of the light housing to the mirror unit.

16. The method of claim 14, wherein a mating contour of the trim piece and a mating contour of the light housing are similar, enabling the light housing's attachment to the mirror unit in place of the trim piece.

17. The method of claim 14 further comprising the light housing to include a mounting periphery adapted to substantially mate with a peripheral attachment portion of the mirror unit such that upon an attachment, the light housing, the light source, and the mirror unit, form an integrated unit.

18. The method of claim 14, wherein the light source is sealed within the opening of the light housing through a sealing grommet.

19. The method of claim 14, wherein the light housing is a light strobe mount.

20. The method of claim 14, wherein the light source is at least one of the following
an emergency light; and
a light emitting diode.
